(19) United States
(12) Patent Application Publication
(10) Pub. No.: US 2013/0273254 A1
(43) Pub. Date: Oct. 17, 2013

(54) POLYMIDE FILM AND METHOD FOR MANUFACTURING THE SAME

(71) Applicants: Yen-Huey Hsu, Pingjhen City (TW); Der-Jen Sun, Pingjhen City (TW)

(72) Inventors: Yen-Huey Hsu, Pingjhen City (TW); Der-Jen Sun, Pingjhen City (TW)

(73) Assignee: Mortech Corporation, Pingjhen City (TW)

(21) Appl. No.: 13/616,047

(22) Filed: Sep. 14, 2012

(30) Foreign Application Priority Data
Apr. 13, 2012 (TW) 101113272

(51) Int. Cl. C08L 79/08; C08K 3/04; C08K 3/36; B05D 7/24; B05D 3/02; B82Y 30/00

(52) U.S. Cl. 427/379; 524/876; 524/847; 977/773

(57) ABSTRACT

A black matte polyimide film having inorganic particles and carbon particles is provided. The polyimide film has a thickness ranging from 12 μm to 250 μm. The polyimide film includes 1 wt % to 49 wt % of the carbon particles and 1 wt % to 49 wt % of the inorganic particles. Each of the carbon particles and the inorganic particles respectively has a particle size ranging from about 0.1 μm to about 10 μm. The polyimide film is characterized in that the 60° lustrousness is equal to or less than 60 Gloss Unit (GU). The thermal expansion coefficient (CTE) is equal to or less than 30 ppm/° C. The light transmittance is equal to or less than 10%. A method for manufacturing the polyimide film is disclosed as well.

### RELATED APPLICATIONS

This application claims priority to Taiwan Application Serial Number 101113272, filed Apr. 13, 2012, which is herein incorporated by reference.

### BACKGROUND

1. Technical Field

The present disclosure relates to a polyimide film. More particularly, the present disclosure relates to a black matte polyimide film having a low thermal expansion coefficient (CTE) for light extinction.

2. Description of Related Art

Polyimide (PI) is an insulating polymer exhibiting high mechanical strength and high thermal resistance, and has been widely applied in a field of flexible printed circuit board (FPCB) or other related fields. For instance, a method for manufacturing the FPCB is to form circuits on a flexible copper-clad laminate (FCCL), and then to cover another polyimide film having an adhesive layer on the circuits. Therefore, the polyimide film has been becoming an integral part of the FPCB in electronic products.

The process for manufacturing the FPCB includes a high temperature step. However, materials, e.g. the polyimide film and the copper foil, of the FCCL respectively have different amounts of thermal expansion, and thus may cause a curl, a fall-off, low adhesion, alignment error etc for the materials. Additionally, it is important for circuit design of the modern electronic products to be confidential Therefore, there is still a need for solving the thermal expansion problem, keeping circuit design confidential, increasing appearance of texture, preventing glare and astigmatism.

### SUMMARY

In recent years, shells of consumer electronic products in people's livelihood, such as mobile phones and laptops, are developed toward having an extinction color outside due to fierce competition. A black matte surface for light extinction becomes a fashion trend. Thus, appearance and inside and outside colors of a product are key requirements. A polyimide film exhibits high gloss in general, but there is a need for a black matte polyimide film for the sake of appearance of texture.

The polyimide film can be acted as a light-shielding film on a lens of a camera or a microscope. If a surface of the polyimide film exhibits very high gloss, it would cause glare or astigmatism because of a light reflection. Thus, a black matte polyimide film is in line with such requirements.

The present disclosure provides a method for manufacturing a polyimide film. In one embodiment, inorganic particles and carbon particles are added into a solvent and then rapidly stirred and dispersed (frequency in a range of 20 Hertz (Hz) to 200 Hz) to prepare a suspension solution containing the inorganic particles and the carbon particles. Dispersing two or more species of particles can reduce aggregation of identical particles and generate mutual dispersion effect. In other words, a well-dispersed micron level dispersion solution can be prepared without performing any grinding step or adding any dispersing agent. Sequentially, a diamine monomer is added into the suspension solution to dissolve, and a dianhydride monomer is then added for performing polymerization with the diamine monomer. A polyamic acid mixture containing the inorganic particles and the carbon particles is formed. Afterwards, the polyamic acid mixture is coated and then dried to form a polyamic acid mixture film. Finally, the polyamic acid mixture film is heated for performing imidization to form the polyimide film. The polyimide film can be a bare membrane to apply in related fields as required.

According to one embodiment of the preset disclosure, during the step of preparing the polyamic acid mixture, the polyamic acid mixture containing the inorganic particles and the carbon particles is stirred to prevent those particles from deposition and further stratification. After completing the polymerization reaction, a polyamic acid mixture solution exhibiting high viscosity is obtained. The polyamic acid mixture solution exhibiting high viscosity can be used to avoid those particles from deposition due to stop stirring. Therefore, the viscosity of the polyamic acid mixture is in a range of 100 poises to 1,000 poises (i.e. 10,000 cps to 100,000 cps). Also, the polyamic acid mixture is coated on a substrate and then dried to form the polyamic acid mixture film.

According to one embodiment of the present disclosure, the inorganic particles have a weight percent ranging from 1 wt % to 49 t %, preferably from 20 wt % to 40 wt %. According to another embodiment of the present disclosure, each of the inorganic particles has a particle size ranging from 0.1 μm to 10 μm, preferably from 0.5 μm to 6 μm. According to another embodiment of the present disclosure, each of the inorganic particles is selected from the group consisting of mica powder, silica powder, talcum powder, ceramic powder, clay powder, silica gel sintered powder and a combination thereof.

According to one embodiment of the present disclosure, the carbon particles have a weight percent ranging from 1 wt % to 49%, preferably from 3 wt % to 30%. According to another embodiment of the present disclosure, each of the carbon particles has a particle size ranging from 0.1 μm to 10 μm, preferably from 0.5 μm to 6 μm. According to another embodiment of the present disclosure, each of the carbon particles is selected from the group consisting of carbon black and carbon gray, formed from complete and incomplete combustion of oil, charcoal, and other organic materials, graphite, carbon sphere, carbon tube, graphene and a combination thereof.

According to one embodiment of the present disclosure, the solvent is selected from the group consisting of N,N-dimethyl formamide (DMF), dimethylacetamide (DMAc), dimethyl sulfoxide (DMSO), N-methyl-2-pyrrolidone (NMP) and a combination thereof.

According to one embodiment of the present disclosure, a molar ratio of the dianhydride monomer to the diamine monomer is in a range of 0.9:1 to 1.1:1.

According to one embodiment of the present disclosure, the dianhydride monomer is selected from the group consisting of 1,2,4,5-benzene tetracarboxylic dianhydride, 3,3′,4,4′-biphenyl tetracarboxylic dianhydride, 4,4′-oxydiphthalic anhydride, benzophenonetetracarboxylic dianhydride, 3,3′,4,4′-diphenyl sulfonetetracarboxylic dianhydride, 1,2,5,6-naphthalene tetracarboxylic dianhydride, 1,4,5,8-naphthalene tetracarboxylic dianhydride, bis(3,4-dicarboxyphenyl)dimethylsilane dianhydride, 1,3-bis(4′-phthalic anhydride)-tetramethyldisiloxane and a combination thereof.

According to one embodiment of the present disclosure, the diamine monomer is selected from the group consisting of 1,4-diamino benzene, 1,3-diamino benzene, 4,4′-oxydianiline, 3,4′-oxydianiline, 4,4′-methylene dianiline, N,N′-diphenylethylene diamine, diaminobenzophenone, diamino diphenyl sulfone, 1,5-naphthalene diamine, 4,4′-diamino diphenyl sulfide, 1,3-Bis(3-aminophenoxy)benzene, 1,4-Bis(4-aminophenoxy)benzene, 1,3-Bis(4-aminophenoxy)benzene, 2,2-Bis[4-(4-aminophenoxy)phenyl]propane, 4,4′-Bis-(4-aminophenoxy)biphenyl, 4,4′-Bis-(3-aminophenoxy)biphenyl, 1,3-Bis(3-aminopropyl)-1,1,3,3-tetramethyldisiloxane, 1,3-Bis(3-aminopropyl)-1,1,3,3-tetraphenyldisiloxane, 1,3-Bis(3-aminopropyl)-1,1-dimethyl-3,3-diphenyldisiloxane and a combination thereof.

According to one embodiment of the present disclosure, the polyamic acid has a viscosity ranging from 100 poises to 1000 poises.

According to one embodiment of the present disclosure, the step of drying the polyamic acid mixture is in a temperature range of 120° C. to 200° C. According to another embodiment of the present disclosure, the step of heating the polyamic acid mixture film is in a temperature range of 270° C. to 400° C.

According to one embodiment of the present disclosure, the polyimide film has a thickness ranging from 12 μm to 250 μm.

Further, a polyimide film fabricated according to the methods mentioned above. According to one embodiment of the present disclosure, the polyimide film includes polyimide, inorganic particles and carbon particles. The inorganic particles and the carbon particles are dispersed in the polyimide to form the polyimide film.

According to one embodiment of the present disclosure, 60° lustrousness of the polyimide film is equal to or less than 60 Gloss Unit (GU). According to another embodiment of the present disclosure, the thermal expansion coefficient (CTE) of the polyimide film is equal to or less than 30 ppm/° C. According to another embodiment of the present disclosure, the thermal expansion coefficient of the polyimide film is substantially the same as the thermal expansion coefficient of a copper foil. According to another embodiment of the present disclosure, the light transmittance of the polyimide film is in a range of 10% to 0%.

### BRIEF DESCRIPTION OF THE DRAWINGS

The disclosure may be more fully understood by reading the following detailed description of the embodiment, with reference made to the accompanying drawings as follows:

FIG. 1 is a flow chart of a method for manufacturing a polyimide film having inorganic particles and carbon particles according to one embodiment of the present disclosure.

### DETAILED DESCRIPTION

The present disclosure is described by the following specific embodiments. Those with ordinary skill in the arts can readily understand the other advantages and functions of the present disclosure after reading the disclosure of this specification. The present disclosure can also be implemented with different embodiments. Various details described in this specification can be modified based on different viewpoints and applications without departing from the scope of the present disclosure.

Reference will now be made in detail to the embodiments of the present disclosure, examples of which are illustrated in the accompanying drawings. Wherever possible, the same reference numbers are used in the drawings and the description to refer to the same or like parts.

### Method for Preparing Polyimide Film

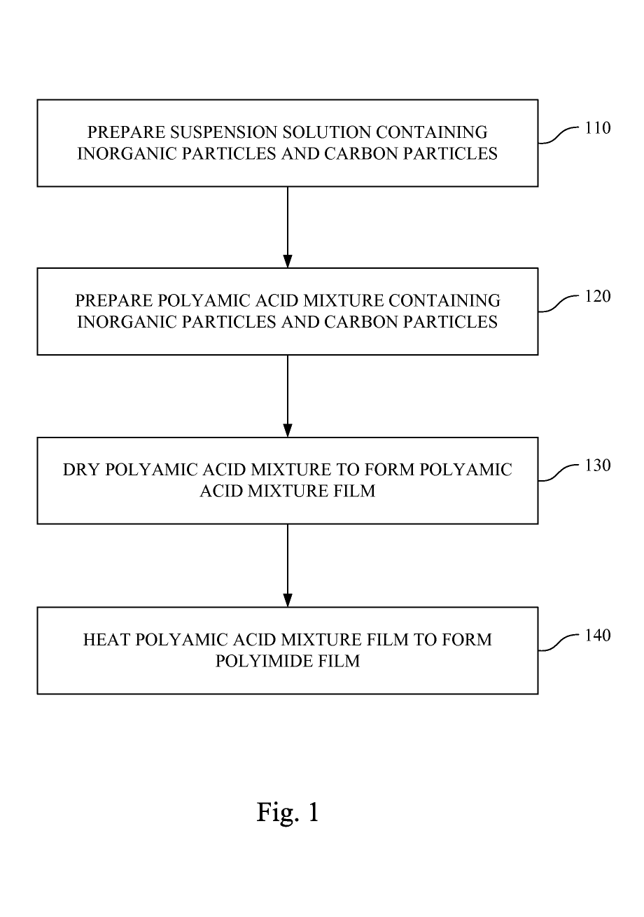

FIG. 1 is a flow chart of a method for manufacturing a polyimide film having inorganic particles and carbon particles according to one embodiment of the present disclosure.

In step 110, inorganic particles and carbon particles are added into a solvent and then rapidly stirred and dispersed (frequency in a range of 20 Hz to 200 Hz) to prepare a suspension solution containing those particles. Dispersing two or more species of particles can reduce aggregation of identical particles and generate mutual dispersion effect. In other words, a well-dispersed micron-level dispersion can be prepared without performing any grinding step or adding any dispersing agent. It is important to notice that any mixing method for achieving the purpose above is applicable to the present disclosure.

Whether the inorganic particles or the carbon particles are too big or too small, it would adversely affect the polyimide film. In one aspect, if each of the inorganic particles and the carbon particles has a particle size larger than 10 μm, the surface of the polyimide film would too rough to apply in electronic products. In another aspect, if each of the inorganic particles and the carbon particles has a particle size less than 0.1 μm, those particles may aggregate, poorly disperse and not easy to control in a process operation. According to one embodiment of the present disclosure, each of the inorganic particles and the carbon particles has a particle size ranging from 0.1 μm to 10 μm, preferably from 0.5 μm to 6 μm.

According to another embodiment of the present disclosure, each of the inorganic particles is selected from the group consisting of mica powder, silica powder, talcum powder, ceramic powder, clay powder, Kaolin clay, silica gel sintered powder and a combination thereof. The ceramic powder can be silicon carbide, boron nitride, alumina or aluminum nitride, but not limited thereto.

According to another embodiment of the present disclosure, each of the carbon particles is selected from the group consisting of carbon black and carbon gray, formed from complete and incomplete combustion of oil, charcoal, and other organic materials, graphite, carbon sphere, carbon tube, graphene and a combination thereof.

According to one embodiment of the present disclosure, the solvent is selected from the group consisting of N,N-dimethyl formamide (DMF), dimethylacetamide (DMAc), dimethyl sulfoxide (DMSO), N-methyl-2-pyrrolidone (NMP) and a combination thereof.

Not only the particle size but also the weight percentage of the inorganic particles or the carbon particles would affect the dispersity.

If the inorganic particles have a weight percent higher than 49 wt %, it would be poorly dispersed; but, if the inorganic particles have a weight percent lower than 1 wt %, 60° lustrousness of the polyimide film would very high (higher than 60 gloss unit) to cause poor matte effect. Thus, the inorganic particles have a weight percent ranging from 1 wt % to 49 wt %, preferably from 20 wt % to 40 wt %.

If the carbon particles have a weight percent higher than 49 wt %, it would be poorly dispersed; but, if the carbon particles have a weight percent lower than 1 wt %, light transmittance of the polyimide film would very high (higher than 10%) and fail to shield light. Thus, the carbon particles have a weight percent ranging from 1 wt % to 49 wt %, preferably from 3 wt % to 30 wt %.

In step 120, a diamine monomer is added into the suspension solution, prepared by step 110, to dissolve, and a dianhydride monomer is then added for performing polymerization with the diamine monomer. Sequentially, the solution is continuously stirred to form a polyamic acid mixture containing the inorganic particles and the carbon particles. In step 120, the diamine monomer and the dianhydride monomer are added into the suspension solution above during continuously stirring. The diamine monomer and the dianhydride monomer polymerize to form polyamic acid.

According to one embodiment of the present disclosure, a molar ratio of the dianhydride monomer to the diamine monomer is in a range of 0.9:1 to 1.1:1.

According to one embodiment of the present disclosure, the diamine monomer is selected from the group consisting of 1,4-diamino benzene, 1,3-diamino benzene, 4,4′-oxydianiline, 3,4′-oxydianiline, 4,4′-methylene dianiline, N,N′-diphenylethylene diamine, diaminobenzophenone, diamino diphenyl sulfone, 1,5-naphthalene diamine, 4,4′-diamino diphenyl sulfide, 1,3-Bis(3-aminophenoxy)benzene, 1,4-Bis(4-aminophenoxy)benzene, 1,3-Bis(4-aminophenoxy)benzene, 2,2-Bis[4-(4-aminophenoxy)phenyl]propane, 4,4′-Bis-(4-aminophenoxy)biphenyl, 4,4′-Bis-(3-aminophenoxy)biphenyl, 1,3-Bis(3-aminopropyl)-1,1,3,3-tetramethyldisiloxane, 1,3-Bis(3-aminopropyl)-1,1,3,3-tetraphenyldisiloxane, 1,3-Bis(3-aminopropyl)-1,1-dimethyl-3,3-diphenyldisiloxane and a combination thereof.

According to one embodiment of the present disclosure, the dianhydride monomer is selected from the group consisting of 1,2,4,5-benzene tetracarboxylic dianhydride, 3,3′,4,4′-biphenyl tetracarboxylic dianhydride, 4,4′-oxydiphthalic anhydride, benzophenonetetracarboxylic dianhydride, 3,3′,4,4′-diphenyl sulfonetetracarboxylic dianhydride, 1,2,5,6-naphthalene tetracarboxylic dianhydride, 1,4,5,8-naphthalene tetracarboxylic dianhydride, bis(3,4-dicarboxyphenyl)dimethylsilane dianhydride, 1,3-bis(4′-phthalic anhydride)-tetramethyldisiloxane and a combination thereof.

The suspension solution prepared by step 110 contains the inorganic particles and the carbon particles, such that the polyamic acid mixture also includes those particles in the polyamic acid. Also, while completing the polymerization reaction in step 120, a polyamic acid mixture solution exhibiting high viscosity can be obtained. The polyamic acid mixture solution exhibiting high viscosity can be used to avoid those particles from deposition due to stop stirring. Therefore, the viscosity of the polyamic acid mixture is in a range of 100 poises to 1000 poises (i.e. 10,000 cps to 100,000 cps).

According to one embodiment of the present disclosure, the polyamic acid mixture prepared by step 120 is coated on a substrate and then dried to form a polyamic acid mixture film.

In step 130, the polyamic acid mixture prepared by step 120 is dried to form a polyamic acid mixture film. The polyamic acid mixture is treated in a high temperature environment to vaporize the solvent and thus retain the polyamic acid mixture film. According to one embodiment of the present disclosure, step 130 is drying in a temperature range of 120° C. to 200° C.

In step 140, the polyamic acid mixture film prepared by step 130 is heated to form the polyimide film. The polyamic acid mixture film is treated in a further high temperature environment to perform imidization reaction and thus form the polyimide film. The polyimide film can be a bare membrane to apply in related fields according to the needs. According to one embodiment of the present disclosure, step 140 is heating in a temperature range of 270° C. to 400° C.

The thickness of the polyimide film formed by step 140 can be selected as required. According to one embodiment of the present disclosure, the polyimide film has a thickness ranging from 12 μm to 250 μm.

### Composition of Polyimide Film

A polyimide film fabricated according to the methods mentioned above includes polyimide, inorganic particles and carbon particles. Both the inorganic particles and the carbon particles are dispersed in the polyimide to form the polyimide film. According to one embodiment of the present disclosure, the inorganic particles of the polyimide film have a weight percent ranging from 1 wt % to 49 t %, preferably from 20 wt % to 40 wt %. According to one embodiment of the present disclosure, the carbon particles of the polyimide film have a weight percent ranging from 1 wt % to 49%, preferably from 3 wt % to 30%.

The methods for testing the polyimide film are provided below. The tests include 60° lustrousness test, light transmittance test and thermal expansion coefficient (CTE) test.

### Preparation of Polyimide Film

### Example 1

### Polyimide Film Containing Inorganic Particles and Carbon Particles (25 μm)

6.98 kg silica powder and 0.977 kg carbon powder are added into 79.07 kg dimethylacetamide (DMAc), and then stirred to form a suspension solution. The silica powder is acted as inorganic particles.

6.71 kg 4,4′-oxydianiline (ODA) and 7.24 kg 1,2,4,5-benzene tetracarboxylic dianhydride (PMDA) are then added into the suspension solution, and then continuously stirred for 6 hours at 20° C. to 30° C. to polymerize and then form a polyamic acid mixture. ODA is acted as a diamine monomer, and PMDA is acted as a dianhydride monomer.

The polyamic acid mixture mentioned above is coated on a substrate and placed in a dry environment, and then dried at 150° C. to form a bare polyamic acid mixture film.

Finally, the polyamic acid mixture film is placed in a heating environment to perform imidization reaction at 300° C. and then form polyimide. The polyimide film of example 1 has a thickness of 25 μm.

According to the testing methods above, the polyimide film of example 1 is tested for 60° lustrousness, light transmittance and thermal expansion coefficient. The 60° lustrousness is 7.5 gloss unit. The light transmittance is 0%. The CTE is 15 ppm/° C.

### Example 2

### Polyimide Film Containing Only Carbon Particles (25 μm)

0.977 kg carbon powder is added into 79.07 kg DMAc, and then stirred to form a suspension solution.

6.71 kg ODA and 7.24 kg PMDA are added into the suspension solution, and then continuously stirred for 6 hours at 20° C. to 30° C. to polymerize and then form a polyamic acid mixture. ODA is acted as a diamine monomer, and PMDA as a dianhydride monomer.

The polyamic acid mixture mentioned above is coated on a substrate and placed in a dry environment, and then dried at 150° C. to form a bare polyamic acid mixture film.

Finally, the polyamic acid mixture film is placed in a heating environment to perform imidization at 300° C. and then form polyimide. The polyimide film of example 2 has a thickness of 25 μm.

According to the testing methods above, the polyimide film of example 2 is tested for 60° lustrousness, light transmittance and thermal expansion coefficient. The 60° lustrousness is 55 gloss unit. The light transmittance is 10%. The CTE is 40 ppm/° C.

### Example 3

### Polyimide Film Free of Inorganic Particles and Carbon Particles (25 μm)

6.71 kg ODA and 7.24 kg PMDA are added into 79.07 kg DMAc, and then continuously stirred for 6 hours at 20° C. to 30° C. to polymerize and then form polyamic acid. ODA is acted as a diamine monomer, and PMDA as a dianhydride monomer.

The polyamic acid mentioned above is coated on a substrate and placed in a dry environment, and then dried at 150° C. to form a bare polyamic acid mixture film.

Finally, the polyamic acid mixture film is placed in a heating environment to perform imidization at 300° C. and then form polyimide. The polyimide film of example 3 has a thickness of 25 μm.

According to the testing methods above, the polyimide film of example 3 is tested for 60° lustrousness, light transmittance and thermal expansion coefficient. The 60° lustrousness is 125 gloss unit. The light transmittance is 100%. The CTE is 40 ppm/° C.

TABLE 1

| | Example 1 | Example 2 | Example 3 |
|---|---|---|---|
| Solvent ^{a} (kg) | 79.07 | 79.07 | 79.07 |
| Inorganic particles ^{b} (kg) | 1.4-7 | none | none |
| Carbon particles ^{c} (kg) | 0.7-4.2 | 0.7-4.2 | none |
| Diamine monomer ^{d} (kg) | 6.71 | 6.71 | 6.71 |
| Dianhydride monomer ^{e} (kg) | 7.24 | 7.24 | 7.24 |
| Thickness (μm) | 25 | 25 | 25 |
| 60° lustrousness (gloss unit) | 40-2 | 80-30 | 125 |
| Light transmittance (%) | 0 | 10-0 | 100 |
| CTE (ppm/° C.) | 15-40 | 40-50 | 40-50 |

^{a} The solvent is DMAc;
^{b} the inorganic particles are selected form the group consisting of mica powder, silica powder, talcum powder, ceramic powder, clay powder, silica gel sintered powder and a combination thereof;
^{c} the carbon particles are selected form the group consisting of carbon black and carbon gray, formed from complete and incomplete combustion of oil, charcoal, and other organic materials, graphite, carbon sphere, carbon tube, graphene and a combination thereof;
^{d} the diamine monomer is ODA;
^{e} the dianhydride monomer is PMDA.

The 60° lustrousness represents a reflective level of a surface of an article. If the 60° lustrousness is lower, the surface is less reflective; that is, the surface exhibits a good matte effect. In Table 1, 60° lustrousness of the polyimide film containing the inorganic particles (Example 1) is significantly much lower compared to the polyimide film free of the inorganic particles (Example 3). Adding inorganic particles can be used to change a shiny surface to a matte surface. The matte surface can effectively reduce light reflection to solve glare and astigmatism problems. All in all, adding inorganic particles can increase matte effect of the polyimide.

The light transmittance results in Table 1 shows that, adding 3 wt % to 30 wt % carbon particles in the polyimide film can apparently reduce light transmittance (see Examples 1 and 2), and low as 0%. Adding carbon particles can make the polyimide film black and opaque. It is important to notice that, although the thickness of the polyimide film is only 25 μm, as long as the adding a adequate amount of the carbon particles and the inorganic particles can make the film reach 0% of light transmittance. This result also provides an effective solution for confidential circuit design. At the same time, the black matte polyimide film also enhances the appearance of texture.

In addition, the results in Table 1, the polyimide film adding both the inorganic particles and the carbon particles (Example 1) exhibits a lower CTE compared to the polyimide film only adding the carbon particles (Example 2). The polyimide film is often laminated with another materials at high temperature. If the difference of the CTEs between the polyimide film and the copper foil is too large, the polyimide film may curl off and cause a big problem during the process. Thus, adjusting the amount of the inorganic particles and the carbon particles can be used to achieve an appropriate CTE range to match the CTE of the corresponding material. For example, the polyimide film free of the inorganic particles (Example 3) has a CTE of 40 to 50 ppm/° C., and a copper foil has a CTE of 17 ppm/° C. If the composition of the polyamic acid mixture is not adjusted, the polyimide film may curl during use. According to one embodiment of the present disclosure, the CTE of the polyimide film can be approximately 17 ppm/° C. in line with the CTE of the copper foil. Thus, the curl problem due to thermal expansion can be solved during use.

### Example 4

### Polyimide Film Containing Inorganic Particles and Carbon Particles (75 μm)

6.32 kg talcum powder and 2.107 kg carbon powder are added into 79.63 kg DMAc, and then stirred to form a suspension solution. The talcum powder is acted as inorganic particles.

4.45 kg ODA, 1.6 kg p-phenylenediamine (p-PDA) and 8 kg PMDA are added into the suspension solution, and then continuously stirred for 6 hours at 20° C. to 30° C. to polymerize and then form a polyamic acid mixture. ODA and p-PDA are acted as a diamine monomer, and PMDA as a dianhydride monomer.

The polyamic acid mixture mentioned above is coated on a substrate and placed in a dry environment, and then dried at 150° C. to form a bare polyamic acid mixture film.

Finally, the polyamic acid mixture film is placed in a heating environment to perform imidization at 350° C. and then form polyimide. The polyimide film of example 4 has a thickness of 75 μm.

According to the testing methods above, the polyimide film of example 4 is tested for 60° lustrousness, light transmittance and thermal expansion coefficient. The 60° lustrousness is 7.0 gloss unit. The light transmittance is 0%. The CTE is 17 ppm/° C.

### Example 5

### Polyimide Film Free of Inorganic Particles and Carbon Particles (75 μm)

4.45 kg, 1.6 kg p-PDA and 8 kg PMDA are added into 79.63 kg DMAc, and then continuously stirred for 6 hours at 20° C. to 30° C. to polymerize and then form polyamic acid. ODA and p-PDA are acted as a diamine monomer, and PMDA as a dianhydride monomer.

The polyamic acid mentioned above is coated on a substrate and placed in a dry environment, and then dried at 150° C. to form a bare polyamic acid mixture film.

Finally, the polyamic acid mixture film is placed in a heating environment to perform imidization at 350° C. and then form polyimide. The polyimide film of example 5 has a thickness of 75 μm.

According to the testing methods above, the polyimide film of example 5 is tested for 60° lustrousness, light transmittance and thermal expansion coefficient. The 60° lustrousness is 120 gloss unit. The light transmittance is >50%. The CTE is 25 to 40 ppm/° C.

TABLE 2

| | | Example 4 | Example 5 |
|---|---|---|---|
| Solvent ^{a} (kg) | | 79.63 | 79.63 |
| Inorganic particles ^{b} (kg) | | 2.8-7.3 | None |
| Carbon particles ^{c} (kg) | | 0.98-2.8 | None |
| Diamine monomer ^{d} (kg) | ODA | 4.45 | 4.45 |
| | p-PDA | 1.60 | 1.60 |

| | | |
|---|---|---|
| Dianhydride monomer ^{e} (kg) | 8.0 | 8.0 |
| Thickness (μm) | 75 | 75 |
| 60° lustrousness (gloss unit) | 30-2 | 120 |
| Light transmittance (%) | 0 | >50 |
| CTE (ppm/° C.) | 15-30 | 25-40 |

^{a} The solvent is DMAc;
^{b} the inorganic particles are selected form the group consisting of mica powder, silica powder, talcum powder, ceramic powder, clay powder, silica gel sintered powder and a combination thereof;
^{c} the carbon particles are selected form the group consisting of carbon black and carbon gray, formed from complete and incomplete combustion of oil, charcoal, and other organic materials, graphite, carbon sphere, carbon tube, graphene and a combination thereof;
^{d} the diamine monomer is ODA and p-PDA;
^{e} the dianhydride monomer is PMDA.

In Table 2, 60° lustrousness, light transmittance and CTE of the polyimide film containing the inorganic particles (Example 4) are apparently much lower compared to the polyimide film free of the inorganic particles (Example 5). Further, adjusting the weight ratio of the inorganic particles and the carbon particles can make the properties of the polyimide film (75 μm) provided in Table 2 similar to those in the Table 1.

As mentioned above, adding the inorganic particles can be employed to increase matte effect and decrease gloss of the surface to solve glare and astigmatism problems. Additionally, it also reduces CTE of the polyimide film to coordinate with another applied substrate having different CTE. Further, adding the carbon particles can be utilized to reduce light transmittance to 0% and completely block light in order to keep secret of confidential circuits or documents. Thus, a high texture black matte polyimide film is prepared.

For demerits of conventional polyimide film, the polyimide film provided by the present disclosure exhibits low gloss and solves the problems of glare, light transmission and thermal expansion. Likewise, the polyimide film provided by the present disclosure exhibits a number of excellent characteristics to directly apply in a variety of high value-added industrial areas and then promote the development of the industry.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. A method for manufacturing a polyimide film, the method comprising the steps of:
dispersing a plurality of inorganic particles and a plurality of carbon particles in a solvent to prepare a suspension solution containing the inorganic particles and the carbon particles;
adding a diamine monomer and a dianhydride monomer into the suspension solution and then performing polymerization to prepare a polyamic acid mixture containing the inorganic particles and the carbon particles;
drying the polyamic acid mixture to form a polyamic acid mixture film; and
heating the polyamic acid mixture film and then performing imidization to form the polyimide film.

2. The method of claim 1, after the step of adding the diamine monomer and the dianhydride monomer into the suspension solution, further comprising:
continuously stirring the polyamic acid mixture containing the inorganic particles and the carbon particles to prevent the inorganic particles and the carbon particles from deposition and further stratification; and
coating the polyamic acid mixture on a substrate.

3. The method of claim 1, wherein the inorganic particles have a weight percent ranging from 1 wt % to 49 wt %.

4. The method of claim 1, wherein the inorganic particles have a weight percent ranging from 20 wt % to 40 wt %.

5. The method of claim 1, wherein each of the inorganic particles has a particle size ranging from 0.1 μm to 10 μm.

6. The method of claim 1, wherein each of the inorganic particles has a particle size ranging from 0.5 μm to 6 μm.

7. The method of claim 1, wherein each of the inorganic particles is selected from the group consisting of mica powder, silica powder, talcum powder, ceramic powder, clay powder, Kaolin clay, silica gel sintered powder and a combination thereof.

8. The method of claim 1, wherein the carbon particles have a weight percent ranging from 1 wt % to 49%.

9. The method of claim 1, wherein the carbon particles have a weight percent ranging from 3 wt % to 30%.

10. The method of claim 1, wherein each of the carbon particles has a particle size ranging from 0.1 μm to 10 μm.

11. The method of claim 1, wherein each of the carbon particles has a particle size ranging from 0.5 μm to 6 μm.

12. The method of claim 1, wherein each of the carbon particles is selected from the group consisting of carbon black and carbon gray, formed from complete and incomplete combustion of oil, charcoal, and other organic materials, graphite, carbon sphere, carbon tube, graphene and a combination thereof.

13. The method of claim 1, wherein the polyimide film has a 60° lustrousness equal to or less than 60 Gloss Unit (GU).

14. The method of claim 1, wherein the polyimide film has a thermal expansion coefficient (CTE) equal to or less than 30 ppm/° C.

15. The method of claim 1, wherein the polyimide film has a light transmittance equal to or less than 10%.

16. A polyimide film fabricated according to the method of claim 1, comprising:
polyimide;
inorganic particles; and
carbon particles,
wherein the inorganic particles and the carbon particles are dispersed in the polyimide to form the polyimide film.
